(19) United States
(12) Patent Application Publication
(10) Pub. No.: US 2025/0130996 A1
(43) Pub. Date: Apr. 24, 2025

(54) QUERY PLANNING AND EXECUTION BASED ON HEURISTICS AND CONTEXTUAL STATISTICS IN A DATABASE SYSTEM

(71) Applicant: Salesforce, Inc., San Francisco, CA (US)

(72) Inventor: Jyothi BALAKA, San Ramon, CA (US)

(73) Assignee: Salesforce, Inc., San Francisco, CA (US)

(21) Appl. No.: 18/491,363

(22) Filed: Oct. 20, 2023

(51) Int. Cl. G06F 16/2453; G06F 11/34; G06F 16/2455

(52) U.S. Cl. CPC G06F 16/24542; G06F 11/3409; G06F 16/24552

(57) ABSTRACT

A request to execute a database query against a database system may be received. The request may identify a database context of a plurality of database contexts in which to execute the database query. Usage statistic values for the database system may be determined. The usage statistic values may include a contextual usage statistic value that is specific to the database context. A database query execution plan may be determined based at least in part on the contextual usage statistic value. The database query execution plan may include a plurality of operations to perform to execute the database query. A database query result may be determined by performing the plurality of operations within the database system.

### FIELD OF TECHNOLOGY

This patent application relates generally to database systems, and more specifically to query planning and execution in database systems.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks. An organization may access cloud computing services via a tenant account through which users associated with the organization may interact with the cloud computing environment.

One type of cloud computing service is a database system. A database system implemented in a cloud computing environment may store information associated with various users and tenants of a cloud computing system. Such information may be communicated directly with a user or tenant or may be used by a cloud computing application performing operations related to a user or tenant.

A database system is accessed via database queries. A query execution plan outlines a step-by-step process by which a database system retrieves and manipulates data to fulfill a given query. The cost-based model helps to select a query execution plan among possible options, for instance based on query efficiency. The query execution plan and cost-based model are central components of many database management systems and often play an important role in improving query performance. Accordingly, improved techniques for query execution planning and cost-based modeling in a cloud computing environment are desired.

### BRIEF DESCRIPTION OF THE DRAWINGS

The included drawings are for illustrative purposes and serve only to provide examples of possible structures and operations for the disclosed inventive systems, apparatus, methods, and computer program products for database system query planning and execution. These drawings in no way limit any changes in form and detail that may be made by one skilled in the art without departing from the spirit and scope of the disclosed implementations.

FIG. 1 illustrates an overview method for executing a database system query, performed in accordance with one or more embodiments.

FIG. 2 illustrates a database system, configured in accordance with one or more embodiments.

FIG. 3 illustrates a method for determining a database query execution plan, performed in accordance with one or more embodiments.

FIG. 4 illustrates a method for executing a database query, performed in accordance with one or more embodiments.

FIG. 5 shows a block diagram of an example of an environment that includes an on-demand database service configured in accordance with some implementations.

FIG. 6A shows a system diagram of an example of architectural components of an on-demand database service environment, configured in accordance with some implementations.

FIG. 6B shows a system diagram further illustrating an example of architectural components of an on-demand database service environment, in accordance with some implementations.

FIG. 7 illustrates one example of a computing device, configured in accordance with one or more embodiments.

FIG. 8 illustrates a method for determining contextual statistics, performed in accordance with one or more embodiments.

### DETAILED DESCRIPTION

Techniques and mechanisms described herein provide for the analysis of potentially complex database queries. In particular, techniques and mechanisms described herein relate to the formulation, selection, and execution of strategies to execute queries to update, retrieve, and/or process data in a database system. A database execution query planner may take into account contextual statistics (e.g., tenant-specific, time-varying information) when constructing database query execution plans. Such an approach may cause the database system to develop and execute different database execution plans for the same query, depending on the context in which the query is executed. By leveraging the insights provided by the cost-based model as expanded to encompass contextual statistics, database administrators and developers as well as the database system itself can make informed decisions about tasks such as query design, index creation, and database schema optimization.

In a conventional database system, a conventional cost-based model considers database-level and table-level factors such as table statistics, available indexes, join strategies, and hardware capabilities to estimate the execution cost of different query plans. However, a conventional cost-based model often leads to inefficient query plans, particularly in a multitenant environment in which multiple databases or tenants share the same database infrastructure. In such a configuration, the varying workloads and resource utilization patterns across tenants and/or databases can lead to skewed statistics and inaccurate cost estimations, resulting in inefficient execution plans. In contrast, techniques and mechanisms described herein provide for adaptive query optimization and machine learning-driven optimizers to dynamically adjust execution plans based on real-time workload characteristics.

Techniques and mechanisms described herein include cost-based models that employ dynamic heuristics utilizing contextual statistics. According to various embodiments, these dynamic heuristics can adapt execution plans based on current workload characteristics and short-term trends. By incorporating contextual statistics, these dynamic heuristics can provide accurate insights into real-time query processing demands. This dynamic approach can empower the query optimizer to make informed decisions, mitigating the complexities of complex database systems such as those that include multitenant environments. Implementing dynamic heuristics may involve coordinating query optimization approaches and database management systems. Additionally, machine learning techniques can predict future workload patterns using historical data, further refining the accuracy of heuristics.

Techniques and mechanisms described herein provide for improved query performance in a database system. In some embodiments, database systems constructed and configured in accordance with techniques and mechanisms described herein may execute more queries in the less time than conventional database system. Alternatively, or additionally, database systems constructed and configured in accordance with techniques and mechanisms described herein may execute queries using fewer hardware and/or software resources than conventional database systems.

According to various embodiments, dynamic heuristics address the limitations of conventional cost models in multitenant settings. By leveraging contextual statistics, dynamic heuristics facilitate responsive query optimization that considers rapidly changing workloads. This dynamic heuristic approach can enhance query performance, improve resource utilization, and/or facilitate efficient query processing in dynamic scenarios.

According to various embodiments, a database query execution plan may include one or more operations to perform in order to respond to the database query. For instance, as a simple example, a database query may seek to retrieve all objects of a particular object type that exhibit a particular characteristic (e.g., SELECT A from TABLE tab WHERE A.val=1). Suppose that the table “tab” is very large, containing many billions of rows. If there are many records where A.val=1 and the query is expected to return billions of rows, since an index-based scan would be slower in this case. If instead there are few records where A.val=1 and the query is expected to return only a handful of rows, then the most efficient query execution plan may involve an index scan. Such analysis may be conducted by a conventional database query planner based on a conventional cost model.

Continuing the example, now suppose that the table “tab” is used to store data from two different tenants, Acme and Globex, and that the same query in the example above would return only a handful of rows for Acme but billions of rows for Globex. In this example, a conventional database execution planner using a conventional cost model would determine and implement the same query execution plan for the query, regardless of whether it was executed for Acme or Globex, based on the overall characteristics of the table “tab”. However, such an approach would be quite inefficient for at least one of the two tenants.

In contrast to this conventional approach, various embodiments described herein include database systems that can dynamically and adaptively create database query execution plans based on tenant-varying statistics. For instance, continuing the example from the previous paragraph, the database system may separately analyze the database usage of Acme and Business. Based on this analysis, the database system may determine that when the query “SELECT A from TABLE tab WHERE A.val=1” is received for Acme, a database query execution plan that involves an index scan should be used. In contrast, when the same query is received for Globex, a different database query execution plan that involves a full table scan should be used. Employing these different database query execution plans rather than a one-size-fits-all approach may yield considerable efficiency gains, even in this simple example.

In some embodiments, the database system may analyze situations much more complex than this simple example. Consider, for instance, variation in the use of database resources, since the most efficient query in times of high database usage may be different from the most efficient query in times of low database usage. For example, a tenant's database usage may vary over time, such as based on time of day (e.g., business hours), day of the week (e.g., popular shopping days), and/or month of the year (e.g., a holiday season). As another example, even if database usage for a particular tenant is low, the tenant's data may be situated on a database server or in a geographic region where database usage by other tenants is high. Thus, contextual (e.g., time-varying) statistics for a tenant may depend not only on the database usage for that tenant, but also on other tenants that are using shared resources. The database system may not only observe such variation as it occurs, but may also predict changes that are likely to occur in the future. The database system may then determine database query execution plans to and proactively adapt to both current and future tenant-varying statistics.

In some embodiments, a database system may be or include a multitenant database environment. In a multitenant database environment, data from different tenants is stored in the same database system. Depending on table configuration, data from different tenants may be stored in a shared database table, different database tables within the same database, or within different databases in the same database system. In a multitenant database environment, the database context in which a database query is executed may be tenant-specific. However, the techniques and mechanisms described herein are not limited to multitenant environments. For example, regardless of whether a database system includes a multitenant environment, a database query may be executed in a database context that is specific to a geographic region, a domain, a subdomain, one or more servers, and/or other divisions of a cloud computing environment. Moreover, the term “tenant” does not necessarily imply that the database system itself is arranged in a multitenant configuration. Rather, the term “tenant” can refer to an entity accessing cloud computing services via a cloud computing environment, regardless of whether the database system includes a multitenant environment.

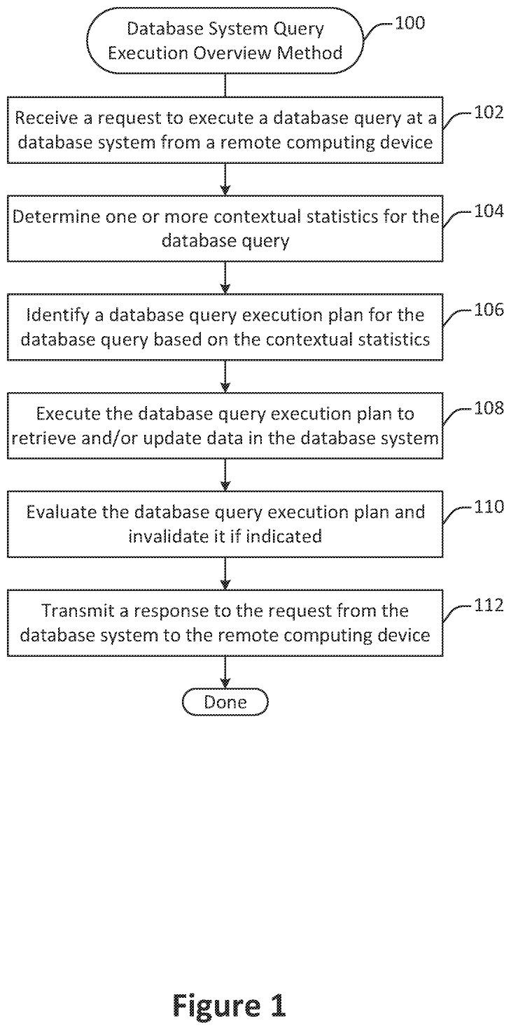

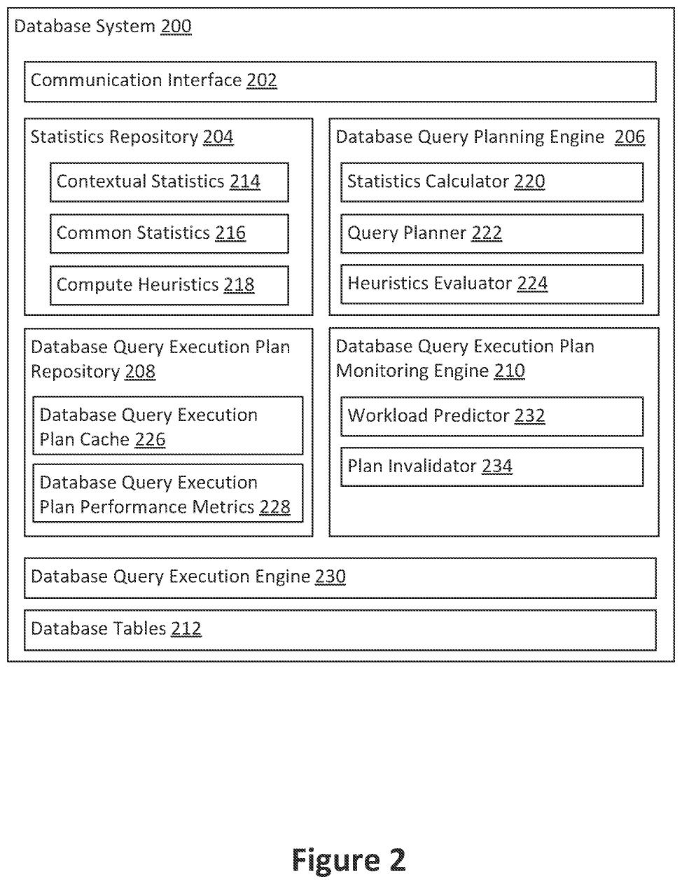

FIG. 1 illustrates an overview method 100 for executing a database system query, performed in accordance with one or more embodiments. The method 100 may be executed at a database system implemented in a cloud computing environment. For instance, the method 100 may be executed at the database system 200 shown in FIG. 2.

A request to execute a database query is received at 102 at a database system from a remote computing device. In some embodiments, the remote computing device may be located outside of the computing services environment in which the database system resides. For instance, the remote computing device may be a client machine in communication with the database system via the internet.

In some embodiments, the remote computing device may be located within the same computing services environment in which the database system resides. For instance, the remote computing device may be an application server located within the computing services environment and configured to provide cloud computing services to users and tenants via the internet.

One or more contextual statistics for the database query are determined at 104. According to various embodiments, a contextual statistic describes information that may vary based on the query context in which the database query is to be executed. The query context may identify a location and/or set of data for executing the query. For example, the query context may include information such as a database tenant for whom the database query is to be executed. As another example, the query context may include information such as one or more servers within a group of servers on which the database query is to be executed. As yet another example, the query context may include information such as a geographic region in which the database query is to be executed. Thus, two different requests to execute the same database query may differ in the context in which the queries are to be executed.

According to various embodiments, the contextual statistic may include any information that varies based on query context. For instance, contextual statistics may include, but are not limited to: a number of database users, a number of database accounts, a rate of data retrieval during a period of time, a number of records accessed in a period of time, a rate of data stored or updated during a period of time, a number of records stored or updated in a period of time, a number of database requests in a period of time, an amount of database resources used or available during a period of time, an amount of computing resources used or available during a period of time, and/or any other suitable information. Thus, two different requests to execute the same database query may differ in their contextual statistics due to a difference in the context in which the queries are to be executed.

In some embodiments, one or more contextual statistics may be cached. In such a situation, determining the one or more contextual statistics may involve retrieving the information from a cache. Alternatively, one or more contextual statistics may not be stored in a cache or may be out of date. In such a situation, determining the one or more contextual statistics may involve evaluating database activity to calculate the one or more contextual statistics.

A database query execution plan is identified for the query at 106 based on the contextual statistics. In some embodiments, identifying the database query execution plan may involve evaluating one or more heuristics to determine a database query execution plan applicable for the database query given the contextual statistics.

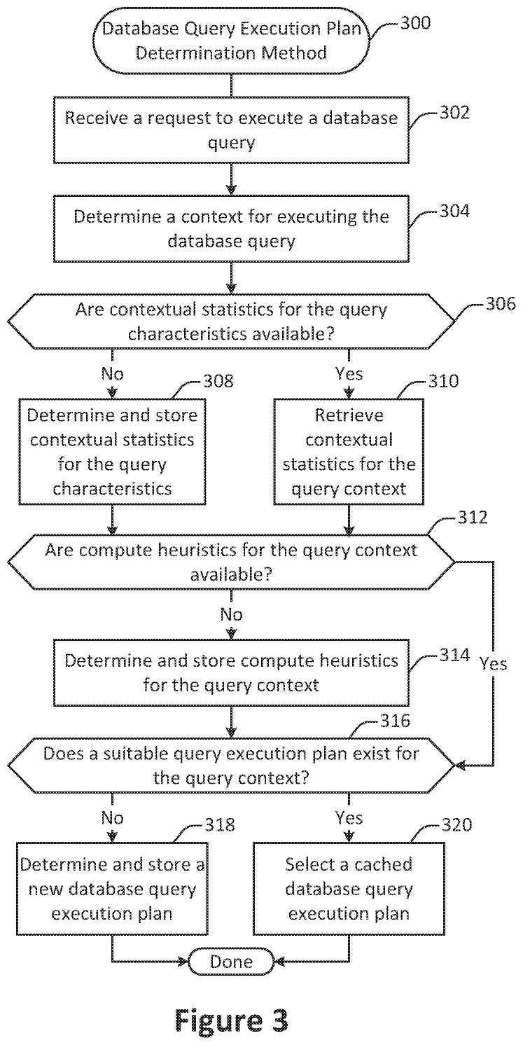

In some embodiments, one or more database query execution plans may be cached. In such a situation, identifying the database query execution plan may involve retrieving the plan from a cache based on the one or more heuristics as applied to the contextual statistics. Alternatively, a database query execution plan corresponding to one or more heuristics as applied to the contextual statistics may not be stored in a cache. For instance, the database query execution plan may have been previously invalidated. In such a situation, identifying the database query execution plan may involve evaluating the database query in view of the contextual statistics to determine a new database query execution plan. Additional details regarding the determination of contextual statistics and the identification of a database query execution plan are discussed with respect to the method 300 shown in FIG. 3.

The database query execution plan is executed at 108. According to various embodiments, executing the database query execution plan may involve performing one or more operations involving the database system, as specified in the plan. For example, executing the database query execution plan may involve retrieving data from one or more database tables, storing data in one or more database tables, joining data retrieved from database tables, and the like.

The database query execution plan is evaluated at 110 and invalidated if indicated. In some embodiments, as discussed herein, a database query execution plan may be stored in a cache for subsequent use, for instance when the same or similar database query is received in the future. Accordingly, evaluating the database query execution plan may involve monitoring performance of the database query execution plan and storing the performance information for subsequent analysis. The performance of the database query execution plan may then be monitored over time to determine whether the plan remains efficient. If the efficiency of the execution of the database query execution plan declines sufficiently over time, the database query execution plan may be invalidated, for instance by removing it from the cache. Then, when another request to execute the same or similar database query is received, the absence of a cached database query execution plan may cause the system to determine a new plan, for instance one more suitable to changes in the contextual statistics over time.

A response to the request is transmitted at 112 from the database system to the remote computing device. According to various embodiments, the nature of the transmission of the response may depend on factors such as the type of database query being executed. For example, the response message may include data retrieved by the database query. As another example, the response message may include confirmation information, such as an indication that the database query has been executed, an indication of the number of database table rows affected by the query, an indication of the database query execution time, and/or any other suitable information.

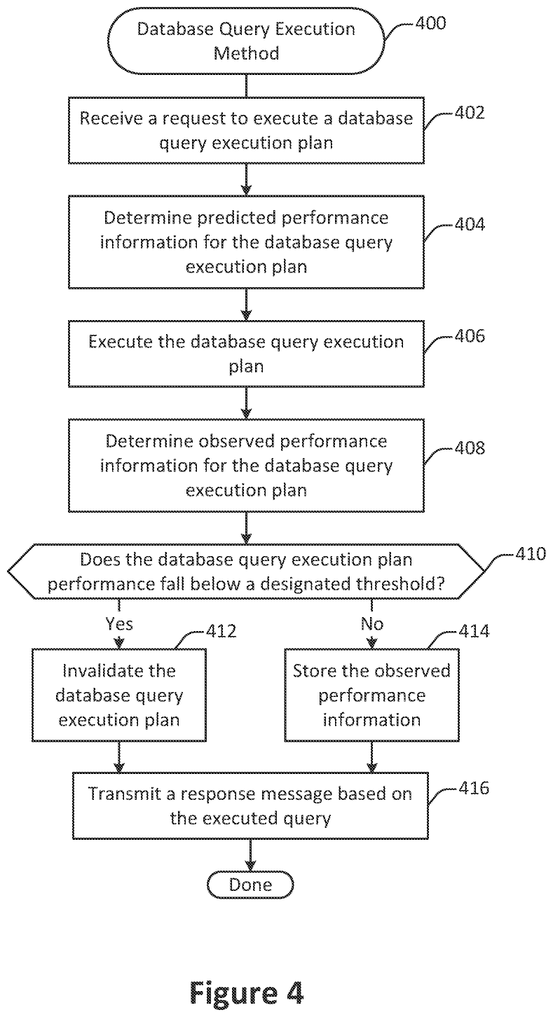

According to various embodiments, the nature of the transmission of the response may depend on factors such as the source of the database query. For example, the response message may be sent to a client machine in communication with the database system via the internet. As another example, the response message may be sent to an application server within the computing services system in which the database system resides. Additional details regarding the execution and evaluation of the database query execution plan are discussed with respect to the method 400 shown in FIG. 4.

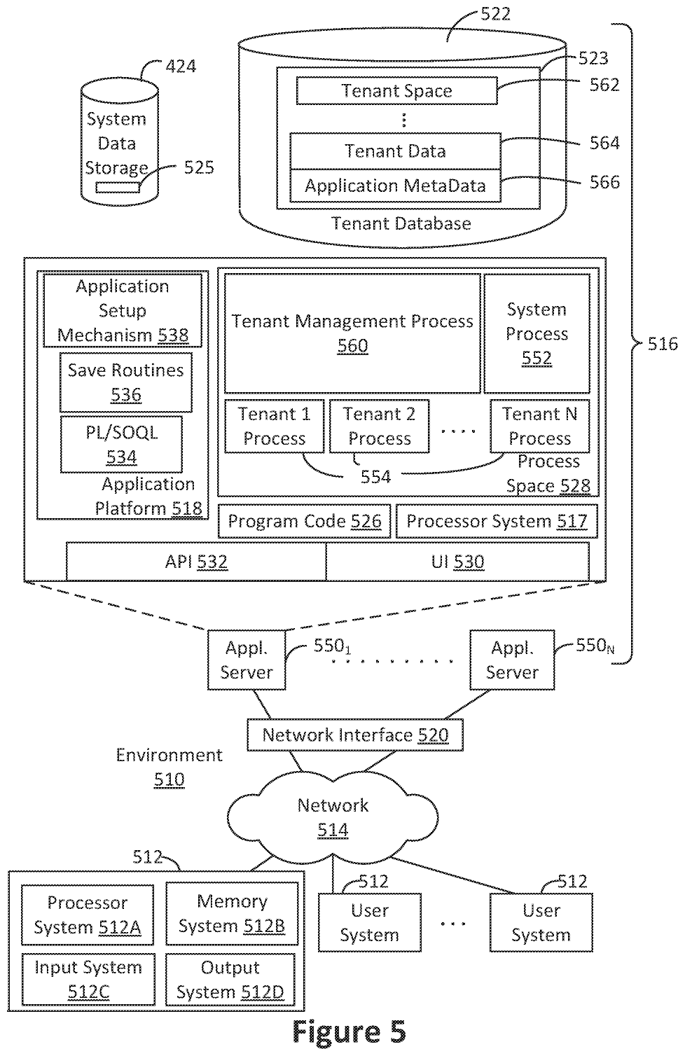

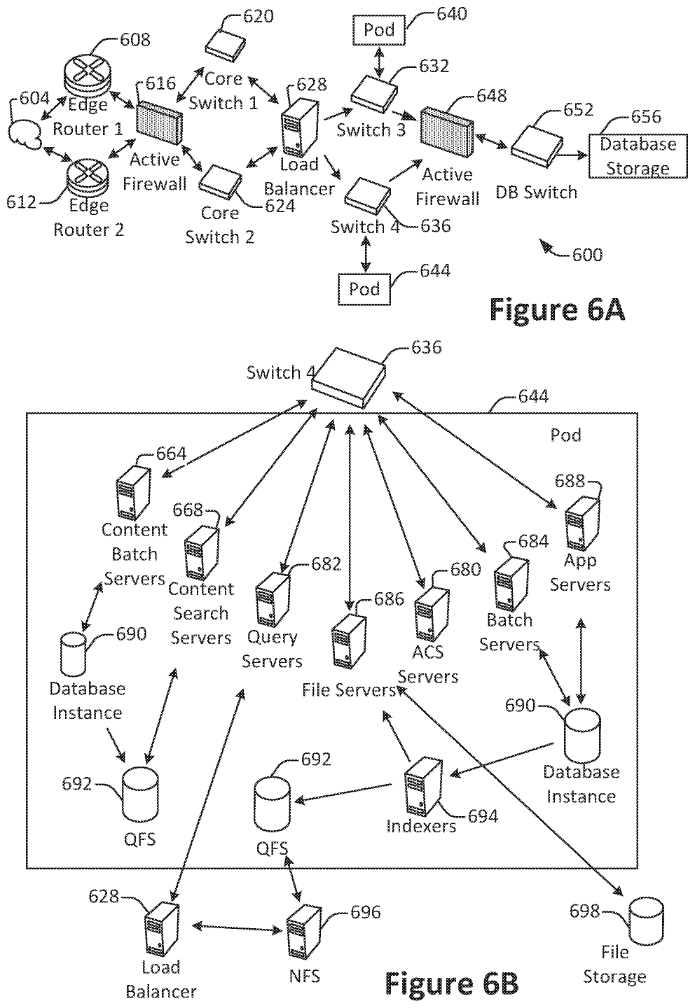

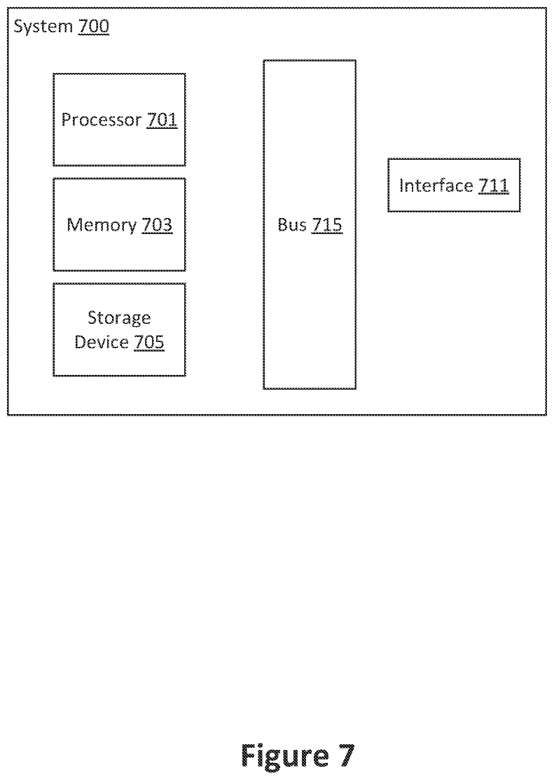

FIG. 2 illustrates a database system 200, configured in accordance with one or more embodiments. The database system 200 may be implemented in a computing services environment. For instance, the database system 200 may be implemented in conjunction with devices, systems, and components shown in FIG. 5, FIG. 6A, FIG. 6B, and FIG. 7. The database system 200 includes a communication interface 202, a statistics repository 204, a database query planning engine 206, a database query execution plan repository 208, a database query execution plan monitoring engine 210, and one or more database tables 212. The statistics repository 204 includes contextual statistics 214, common statistics 216, and compute heuristics 218. The database query planning engine 206 includes a statistics calculator 220, a query planner 222, a heuristics evaluator 224, and a database query execution engine 230. The database query execution plan repository 208 includes a database query execution plan cache 226 and database query execution plan performance metrics 228. The database query execution plan monitoring engine 210 includes a workload predictor 232 and a plan invalidator 234.

According to various embodiments, the communication interface 202 may be configured to communicate with remote computing devices. The communication interface 202 may be configured to perform operations such as receiving requests to execute queries, providing those queries to other elements of the database system 200, and transmitting responses to queries.

In some embodiments, the statistics repository 204 may be configured to store information guiding the selection of database query execution plans. Such information may then be retrieved by the database query planning engine 206 when performing any of various operations. For instance, the database query planning engine 206 may retrieve information from the statistics repository 204 when determining whether a suitable cached database query execution plan exists, selecting a cached database query execution plan, and/or determining a new database query execution plan.

According to various embodiments, the contextual statistics 214 may include information that may vary rapidly over time. Some such information may be specific to a particular database tenant, such as the database tenant associated with the query. For example, the contextual statistics 214 may include information such as the identity of the tenant, a seasonal workload for the tenant, a geography-specific workload for the tenant, a number of requests per second from the tenant, an amount of data written and/or retrieved for the tenant within a period of time, a number and/or type of active users associated with the tenant, and or any other related information about the tenant or the tenant's database usage.

In some embodiments, information specific to a tenant may include information related to other database tenants. For instance, a tenant's data may reside on a server, in a group of servers, in a geographic region, in a domain, in a subdomain, or in some other unit of computing resources. In such a situation, the unit of computing resources in which the tenant's data resides may also be used to provide services to other tenants. Accordingly, contextual information for a query of the focal tenant's data may include information (e.g., an amount of data written and/or retrieved within a period of time, a number and/or type of active users, a number of requests per second) for other tenants served by the unit of computing resources associated with the tenant.

According to various embodiments, the common statistics 216 may include any statistics common to the database system as a whole. For example, the common statistics 216 may include table-level statistics such as the number of rows in a database table, index information, metadata information, and the like. As another example, the common statistics 216 may include information about data models, accounts, entities, and database tenants.

According to various embodiments, the compute heuristics 218 may include decision-making information for selecting a database query execution plan based on the contextual statistics 214 and/or the common statistics 216. For instance, the heuristics 218 may identify a particular database query execution plan stored in the database query execution plan repository 208 to select when particular conditions are met.

In some embodiments, the database query planning engine 206 may be configured to perform various operations related to selecting and determining a database query execution plan. The statistics calculator 220 may be configured to communicate with other elements of the database system to determine the contextual statistics 214 and/or the common statistics 216. The query planner 222 may be configured to determine a database query execution plan if a suitable plan is not stored in the database query execution plan repository 208. The heuristics evaluator 224 may be configured to select a database query execution plan from the database query execution plan repository 208 based on the compute heuristics 218.

The database query execution plan repository 208 may be configured to store information about database query execution plans that have been executed in the past. Such information includes the database query execution plans themselves, which may be retrieved from the database query execution plan cache 226 for use in executing a new database query similar or identical to one received in the past.

In some embodiments, the database query execution plan performance metrics 228 may store performance information about executed database query execution plans. Such information may include, for instance, a length of time required to execute a database query execution plan, an amount of computing resources used to execute a database query execution plan, a number of records accessed during the execution of a database query execution plan, or any other information useful for evaluating the performance of a database query execution plan.

According to various embodiments, the database query execution plan monitoring engine 210 may be configured to perform operations related to evaluating database query execution plan performance, predicting future workloads, and invalidating database query execution plans when appropriate.

In some embodiments, the workload predictor 232 may predict future workloads for the database system, both common to the database as a whole and for specific tenants and/or portions of the database system. Such predictions may be based on any of a variety of types of information. For example, predictions may be based on current workloads. As another example, predictions may be based on seasonal patterns in database workloads, such as time of day, day of the week, and/or month of the year. As yet another example, predictions may be based on textual analysis of communications. For instance, a textual analysis of communications related to a tenant providing food delivery services in the U.S. may reveal that an upcoming weekend will correspond to the Superbowl, leading to a predicted increase in database traffic related to the food delivery services.

The plan invalidator 234 may evaluate the performance of a database execution plan based historical database query execution plan cache 226. When a plan's performance and efficiency declines below an acceptable level, the plan invalidator 234 may invalidate the plan by removing it from the database query execution plan cache 226.

In some implementations, the database query execution engine 230 may be configured to execute a database query against the one or more database tables 212. Executing a database query execution plan may involve performing the operations specified in the plan. Examples of such operations may include, but are not limited to: retrieving information from a database table, merging retrieved information, selecting a subset of retrieved information, storing information in a database table, and the like.

FIG. 3 illustrates a method 300 for determining a database query execution plan, performed in accordance with one or more embodiments. The method 300 may be executed at a database system such as the database system 200 shown in FIG. 2.

A request to execute a database query for a tenant is received at 302. In some embodiments, the request may be generated as discussed with respect to the operation 102 shown in FIG. 1.

A query context is determined at 304. According to various embodiments, the query context may include any of various information related to a context in which the query is to be executed. For example, the query context may include a database tenant on whose data the query will be executed. As another example, the query context may include a set of computing resources that will be used to execute the query. For instance, the query context may identify one or more servers, geographic regions, domains, subdomains, and/or other units within a cloud computing system. As yet another example, the query context may include information about the source of a query, such as a tenant, user, and/or application that generated the query.

A determination is made at 306 as to whether contextual statistics are available for the query context. In some embodiments, the determination may be made by consulting the contextual statistics 214 stored in the statistics repository 204. For instance, the contextual statistics 214 may be accessed to determine if up-to-date statistics for a tenant, geographic region, and/or group of servers associated with the query are stored.

Upon determining that the contextual statistics for the query context are available, then at 310 the contextual statistics are retrieved. Upon determining instead that contextual statistics for the query context are unavailable, then at 308 contextual statistics for the query characteristics are determined and stored. In some embodiments, the contextual statistics may be determined the statistics calculator 220 in the database query planning engine 206. The statistics calculator 220 may access log information, connection information, query records, and/or other such data associated with the database system to determine contextual statistics for the query characteristics.

According to various embodiments, contextual statistics may include information various information about database usage. For example, the contextual statistics may include a rate of data retrieval and/or storage, a number of active database users, a number of database accounts, an amount of data stored in the database system, a number of database connections, and/or any other relevant information.

According to various embodiments, a contextual statistic may be determined for the context identified at 304. For example, a rate of data retrieval may be determined for the tenant on whose data the database query is to be executed. As another example, a number of active database users may be determined for a geographic region in which the database query is to be executed. As yet another example, an amount of data stored in the database system may be determined for the domain in which the database query is to be executed. As still another example, a percentage of database processing resources may be determined for a group of servers in which the database query is to be executed.

In some embodiments, the contextual statistics may include both observed and predicted information. The observed information may include statistics based on database operations as observed in the past, such as during the last few seconds, minutes, hours, and/or days. The predicted information may include similar statistics predicted for the future, such as during the next few seconds, minutes, hours, and/or days.

A determination is made at 312 as to whether compute heuristics for the query context are available. In some embodiments, compute heuristics may include one or more criteria for selecting a database query execution plan based on the query context. The determination may be made by accessing the compute heuristics 218 stored in the statistics repository 204 based on the heuristics evaluator 224 and the query characteristics. For instance, the heuristics evaluator 224 may be used to identify suitable compute heuristics for the query, and then the statistics repository 204 may be accessed to determine if those compute heuristics 218 are available.

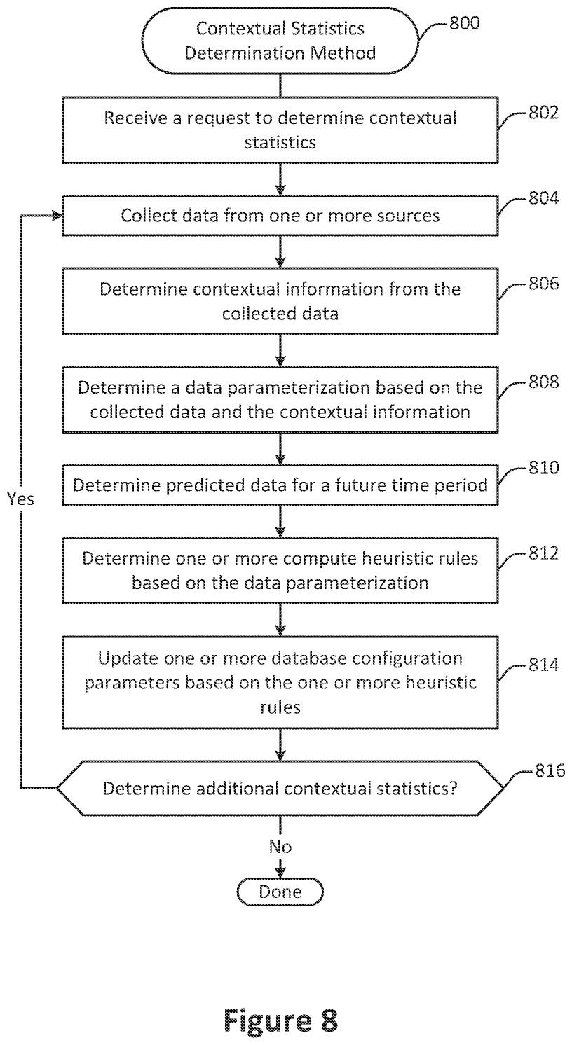

Upon determining the compute heuristics for the query characteristics are unavailable, compute heuristics for the query context are determined and stored at 314. Additional details for determining contextual statistics and compute statistics are discussed with respect to the method 800 shown in FIG. 8.

A determination is made at 316 as to whether a suitable query execution plan exists for the query based on the compute heuristics. In some embodiments, the determination may be made by the heuristics evaluator 224 by applying the compute heuristics to the query characteristics determined at 304, and then accessing the database query execution plan repository 208 to determine if a matching plan is available.

Upon determining instead that a suitable query execution plan is available, the database query execution plan is selected from the database query execution plan cache 226 at 320. Upon determining instead that a suitable query execution plan is unavailable, a new database query execution plan is determined and stored at 318. In some embodiments, the query execution plan may be determined by the query planner 222.

According to various embodiments, the particular operations involved in determining the database query execution plan may depend in significant part on the configuration of the database system. The query planner associated with the database system may be provided with both the query, the contextual statistics, and any common statistics available for the database system. The query planner may determine various possible query execution plans for the query. A cost model may then be determined for the possible query execution plans based on both the common statistics 216 and the contextual statistics 214. An efficient and cost-effective query may then be selected based on the cost model. The query execution plan may then be stored in the database system for future use, for instance when a similar or identical query is received in a similar or identical query context. In this way, the same database query may be associated with different database query execution plans that are created, cached, and selected based on the query context and then updated as needed.

FIG. 4 illustrates a method 400 for executing a database query, performed in accordance with one or more embodiments. The method 400 may be executed on a database system such as the database system 200 shown in FIG. 2.

A request to execute a database query execution plan is received at 402. In some embodiments, the request may be generated as discussed with respect to the operation 108 shown in FIG. 1. The database query execution plan may be determined as discussed with respect to the method 300 shown in FIG. 3.

Predicted performance information for the database query execution plan is determined at 404. According to various embodiments, the predicted performance information may include data such as an anticipated length of time to execute the database query execution plan, a number of records updated and/or retrieved by the database query execution plan, an amount of computing resources employed in executing the database query execution plan, and/or any other information suitable for evaluating database query execution plan performance. The predicted performance information may be determined at least in part by retrieving database query execution plan performance metrics 228 from the database query execution plan repository 208.

The database query execution plan is executed at 406. According to various embodiments, the particular operations involved in executing the database query execution plan may depend in significant part on the plan itself. A database execution plan may include a number of operations to be performed in order to generate a response to a query. Such operations may include retrieving data from one or more database tables, joining data, selecting from retrieved data, updating data, and the like.

Observed performance information for the database query execution plan is determined at 408. In some embodiments, the observed performance information may include any or all of the data predicted at operation 404, as determined for the database query execution plan executed at 406. Such information may be determined by accessing log information, connection information, query records, and/or other such data associated with the database system.

A determination is made at 410 as to whether the database query execution plan performance falls below a designated threshold. In some embodiments, the determination made at 410 may involve various types of analysis. For example, a determination may be made as to whether the query execution time, computing resources used, records accessed, or other such performance indicators exceeds a respective value. The value may be, for instance, a designated percentage (e.g., 120%) of the predicted value.

In some embodiments, more than one threshold may be set, for instance for different performance metrics. Alternatively, or additionally, a joint performance threshold may be determined based on a combination of performance metrics. Various types of performance thresholds may be employed. For instance, more stringent thresholds may improve average database query execution plan performance at the expense of creating new database query execution plans more frequently.

Upon determining that the database query execution plan performance falls below a designated threshold, at 412 the database query execution plan is invalidated. Invalidating the database query execution plan may involve removing it from the database query execution plan cache 226.

Upon determining instead that the database query execution plan performance does not fall below a designated threshold, then at 414 the observed performance information is stored. In some implementations, the observed performance information may be stored as database query execution plan performance metrics 228 in the database query execution plan repository 208.

A response message is transmitted at 416 based on the executed query. The response message may be transmitted as discussed with respect to operation 112 shown in FIG. 1.

FIG. 5 shows a block diagram of an example of an environment 510 that includes an on-demand database service configured in accordance with some implementations. Environment 510 may include user systems 512, network 514, database system 516, processor system 517, application platform 518, network interface 520, tenant data storage 522, tenant data 523, system data storage 524, system data 525, program code 526, process space 528, User Interface (UI) 530, Application Program Interface (API) 532, PL/SOQL 534, save routines 536, application setup mechanism 538, application servers 550-1 through 550-N, system process space 552, tenant process spaces 554, tenant management process space 560, tenant storage space 562, user storage 564, and application metadata 566. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 516, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 518 may be a framework that allows the creation, management, and execution of applications in system 516. Such applications may be developed by the database service provider or by users or third-party application developers accessing the service. Application platform 518 includes an application setup mechanism 538 that supports application developers' creation and management of applications, which may be saved as metadata into tenant data storage 522 by save routines 536 for execution by subscribers as one or more tenant process spaces 554 managed by tenant management process 560 for example. Invocations to such applications may be coded using PL/SOQL 534 that provides a programming language style interface extension to API 532. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 566 for a subscriber making such an invocation. Such system processes may also manage execution of application metadata 566 as an application in a virtual machine.

In some implementations, each application server 550 may handle requests for any user associated with any organization. A load balancing function (e.g., an F5 Big-IP load balancer) may distribute requests to the application servers 550 based on an algorithm such as least-connections, round robin, observed response time, etc. Each application server 550 may be configured to communicate with tenant data storage 522 and the tenant data 523 therein, and system data storage 524 and the system data 525 therein to serve requests of user systems 512. The tenant data 523 may be divided into individual tenant storage spaces 562, which can be either a physical arrangement and/or a logical arrangement of data. Within each tenant storage space 562, user storage 564 and application metadata 566 may be similarly allocated for each user. For example, a copy of a user's most recently used (MRU) items might be stored to user storage 564. Similarly, a copy of MRU items for an entire tenant organization may be stored to tenant storage space 562. A UI 530 provides a user interface and an API 532 provides an application programming interface to system 516 resident processes to users and/or developers at user systems 512.

System 516 may implement a web-based database system. For example, in some implementations, system 516 may include application servers configured to implement and execute database access software applications. The application servers may be configured to provide related data, code, forms, web pages and other information to and from user systems 512. Additionally, the application servers may be configured to store information to, and retrieve information from a database system. Such information may include related data, objects, and/or Webpage content. With a multi-tenant system, data for multiple tenants may be stored in the same physical database object in tenant data storage 522, however, tenant data may be arranged in the storage medium(s) of tenant data storage 522 so that data of one tenant is kept logically separate from that of other tenants. In such a scheme, one tenant may not access another tenant's data, unless such data is expressly shared.

Several elements in the system shown in FIG. 5 include conventional, well-known elements that are explained only briefly here. For example, user system 512 may include processor system 512A, memory system 512B, input system 512C, and output system 512D. A user system 512 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 512 to access, process and view information, pages and applications available from system 516 over network 514. Network 514 may be any network or combination of networks of devices that communicate with one another, such as any one or any combination of a LAN (local area network), WAN (wide area network), wireless network, or other appropriate configuration.

The users of user systems 512 may differ in their respective capacities, and the capacity of a particular user system 512 to access information may be determined at least in part by “permissions” of the particular user system 512. As discussed herein, permissions generally govern access to computing resources such as data objects, components, and other entities of a computing system, such as a database system, a social networking system, and/or a CRM database system. “Permission sets” generally refer to groups of permissions that may be assigned to users of such a computing environment. For instance, the assignments of users and permission sets may be stored in one or more databases of System 516. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 516 may provide on-demand database service to user systems 512 using an MTS arrangement. By way of example, one tenant organization may be a company that employs a sales force where each salesperson uses system 516 to manage their sales process. Thus, a user in such an organization may maintain contact data, leads data, customer follow-up data, performance data, goals and progress data, etc., all applicable to that user's personal sales process (e.g., in tenant data storage 522). In this arrangement, a user may manage his or her sales efforts and cycles from a variety of devices, since relevant data and applications to interact with (e.g., access, view, modify, report, transmit, calculate, etc.) such data may be maintained and accessed by any user system 512 having network access.

When implemented in an MTS arrangement, system 516 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 516 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 516 may also maintain system-level data usable by multiple tenants or other data. Such system-level data may include industry reports, news, postings, and the like that are sharable between tenant organizations.

In some implementations, user systems 512 may be client systems communicating with application servers 550 to request and update system-level and tenant-level data from system 516. By way of example, user systems 512 may send one or more queries requesting data of a database maintained in tenant data storage 522 and/or system data storage 524. An application server 550 of system 516 may automatically generate one or more SQL statements (e.g., one or more SQL queries) that are designed to access the requested data. System data storage 524 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 6A shows a system diagram of an example of architectural components of an on-demand database service environment 600, configured in accordance with some implementations. A client machine located in the cloud 604 may communicate with the on-demand database service environment via one or more edge routers 608 and 612. A client machine may include any of the examples of user systems 512 described above. The edge routers 608 and 612 may communicate with one or more core switches 620 and 624 via firewall 616. The core switches may communicate with a load balancer 628, which may distribute server load over different pods, such as the pods 640 and 644 by communication via pod switches 632 and 636. The pods 640 and 644, which may each include one or more servers and/or other computing resources, may perform data processing and other operations used to provide on-demand services. Components of the environment may communicate with a database storage 656 via a database firewall 648 and a database switch 652.

Accessing an on-demand database service environment may involve communications transmitted among a variety of different components. The environment 600 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 6A and 6B.

The cloud 604 refers to any suitable data network or combination of data networks, which may include the Internet. Client machines located in the cloud 604 may communicate with the on-demand database service environment 600 to access services provided by the on-demand database service environment 600. By way of example, client machines may access the on-demand database service environment 600 to retrieve, store, edit, and/or process information stored in the database system.

In some implementations, the edge routers 608 and 612 route packets between the cloud 604 and other components of the on-demand database service environment 600. The edge routers 608 and 612 may employ the Border Gateway Protocol (BGP). The edge routers 608 and 612 may maintain a table of IP networks or ‘prefixes’, which designate network reachability among autonomous systems on the internet.

In one or more implementations, the firewall 616 may protect the inner components of the environment 600 from internet traffic. The firewall 616 may block, permit, or deny access to the inner components of the on-demand database service environment 600 based upon a set of rules and/or other criteria. The firewall 616 may act as one or more of a packet filter, an application gateway, a stateful filter, a proxy server, or any other type of firewall.

In some implementations, the core switches 620 and 624 may be high-capacity switches that transfer packets within the environment 600. The core switches 620 and 624 may be configured as network bridges that quickly route data between different components within the on-demand database service environment. The use of two or more core switches 620 and 624 may provide redundancy and/or reduced latency.

In some implementations, communication between the pods 640 and 644 may be conducted via the pod switches 632 and 636. The pod switches 632 and 636 may facilitate communication between the pods 640 and 644 and client machines, for example via core switches 620 and 624. Also or alternatively, the pod switches 632 and 636 may facilitate communication between the pods 640 and 644 and the database storage 656. The load balancer 628 may distribute workload between the pods, which may assist in improving the use of resources, increasing throughput, reducing response times, and/or reducing overhead. The load balancer 628 may include multilayer switches to analyze and forward traffic.

In some implementations, access to the database storage 656 may be guarded by a database firewall 648, which may act as a computer application firewall operating at the database application layer of a protocol stack. The database firewall 648 may protect the database storage 656 from application attacks such as structure query language (SQL) injection, database rootkits, and unauthorized information disclosure. The database firewall 648 may include a host using one or more forms of reverse proxy services to proxy traffic before passing it to a gateway router and/or may inspect the contents of database traffic and block certain content or database requests. The database firewall 648 may work on the SQL application level atop the TCP/IP stack, managing applications' connection to the database or SQL management interfaces as well as intercepting and enforcing packets traveling to or from a database network or application interface.

In some implementations, the database storage 656 may be an on-demand database system shared by many different organizations. The on-demand database service may employ a single-tenant approach, a multi-tenant approach, a virtualized approach, or any other type of database approach. Communication with the database storage 656 may be conducted via the database switch 652. The database storage 656 may include various software components for handling database queries. Accordingly, the database switch 652 may direct database queries transmitted by other components of the environment (e.g., the pods 640 and 644) to the correct components within the database storage 656.

FIG. 6B shows a system diagram further illustrating an example of architectural components of an on-demand database service environment, in accordance with some implementations. The pod 644 may be used to render services to user(s) of the on-demand database service environment 600. The pod 644 may include one or more content batch servers 664, content search servers 668, query servers 682, file servers 686, access control system (ACS) servers 680, batch servers 684, and app servers 688. Also, the pod 644 may include database instances 690, quick file systems (QFS) 692, and indexers 694. Some or all communication between the servers in the pod 644 may be transmitted via the switch 636.

In some implementations, the app servers 688 may include a framework dedicated to the execution of procedures (e.g., programs, routines, scripts) for supporting the construction of applications provided by the on-demand database service environment 600 via the pod 644. One or more instances of the app server 688 may be configured to execute all or a portion of the operations of the services described herein.

In some implementations, as discussed above, the pod 644 may include one or more database instances 690. A database instance 690 may be configured as an MTS in which different organizations share access to the same database, using the techniques described above. Database information may be transmitted to the indexer 694, which may provide an index of information available in the database 690 to file servers 686. The QFS 692 or other suitable filesystem may serve as a rapid-access file system for storing and accessing information available within the pod 644. The QFS 692 may support volume management capabilities, allowing many disks to be grouped together into a file system. The QFS 692 may communicate with the database instances 690, content search servers 668 and/or indexers 694 to identify, retrieve, move, and/or update data stored in the network file systems (NFS) 696 and/or other storage systems.

In some implementations, one or more query servers 682 may communicate with the NFS 696 to retrieve and/or update information stored outside of the pod 644. The NFS 696 may allow servers located in the pod 644 to access information over a network in a manner similar to how local storage is accessed. Queries from the query servers 622 may be transmitted to the NFS 696 via the load balancer 628, which may distribute resource requests over various resources available in the on-demand database service environment 600. The NFS 696 may also communicate with the QFS 692 to update the information stored on the NFS 696 and/or to provide information to the QFS 692 for use by servers located within the pod 644.

In some implementations, the content batch servers 664 may handle requests internal to the pod 644. These requests may be long-running and/or not tied to a particular customer, such as requests related to log mining, cleanup work, and maintenance tasks. The content search servers 668 may provide query and indexer functions such as functions allowing users to search through content stored in the on-demand database service environment 600. The file servers 686 may manage requests for information stored in the file storage 698, which may store information such as documents, images, basic large objects (BLOBs), etc. The query servers 682 may be used to retrieve information from one or more file systems. For example, the query system 682 may receive requests for information from the app servers 688 and then transmit information queries to the NFS 696 located outside the pod 644. The ACS servers 680 may control access to data, hardware resources, or software resources called upon to render services provided by the pod 644. The batch servers 684 may process batch jobs, which are used to run tasks at specified times. Thus, the batch servers 684 may transmit instructions to other servers, such as the app servers 688, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

FIG. 7 illustrates one example of a computing device. According to various embodiments, a system 700 suitable for implementing embodiments described herein includes a processor 701, a memory module 703, a storage device 705, an interface 711, and a bus 715 (e.g., a PCI bus or other interconnection fabric.) System 700 may operate as variety of devices such as an application server, a database server, or any other device or service described herein. Although a particular configuration is described, a variety of alternative configurations are possible. The processor 701 may perform operations such as those described herein. Instructions for performing such operations may be embodied in the memory 703, on one or more non-transitory computer readable media, or on some other storage device. Various specially configured devices can also be used in place of or in addition to the processor 701. The interface 711 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

FIG. 8 illustrates a method 800 for determining contextual statistics, performed in accordance with one or more embodiments. According to various embodiments, the method 800 may be performed a database system such as the database system 200 shown in FIG. 2.

A request to determine contextual statistics is received at 802. In some embodiments, the request may be generated as discussed with respect to operation 308 shown in FIG. 3.

Data is collected from one or more sources at 804. According to various embodiments, any of a variety of different types of data may be collected from a variety of sources related to the database system. Examples of data that may be collected may include, but are not limited to: data characterizing real time user interactions, data characterizing devices in communication with the database system, data characterizing one or more operating parameters associated with the database system, data characterizing one or more configuration parameters associated with the database system, and data characterizing performance information for the database system.

Contextual information for the database system is determined at 806. According to various embodiments, the contextual information may include any of a variety of types of data. For example, the contextual information may include seasonality information determined by applying seasonality detection processes to characterize seasonal variation in any of the collected data. As another example, the contextual information may identify one or more environmental factors associated with the database system. As yet another example, the contextual information may identify calendar information such as regional or global holiday periods. As still another example, the contextual information may identify internal information such as database system state. As still another example, the contextual information may identify one or more tenants, servers, sub-systems, or other elements of the database system associated with collected data.

A data parameterization is determined at 808. In some embodiments, the data parameterization may link collected data with contextual information to facilitate heuristic determination, decision-making, prediction, and other such activities. For example, the data parameterization may link contextual elements (e.g., server information, tenant identity, holiday period, seasonal database system usage information, etc.) with observed database system usage (e.g., a number of requests, a volume of data accessed, a percentage of resources utilized, etc.).

Predicted data for a future time period is determined at 810. In some embodiments, the predicted data may be determined by training a supervised prediction model on the parameterized data determined as discussed with respect to operation 808. For instance, the parameterized data may be divided into training and test subsets. The prediction model may then be trained using the training data and evaluated using the test data. This process may be repeated until the model is trained. The trained model may then be used to predict one or more data observations in the future.

One or more compute heuristic rules are determined at 812 based on the data parameterization. According to various embodiments, the compute heuristic rules may be used to select a database query execution plan based on data associated with the database system. For instance, a compute heuristic may indicate that a database query for a particular tenant should be executed using a first database query execution plan when certain conditions are met but should be executed using a second database query execution plan when those conditions are not met.

In some embodiments, the compute heuristic rules may be used to determine one or more database parameters for updating. For instance, the compute heuristic rules may indicate that a number of processors available for database query processing in a geographic region should be increased during a holiday season but should be decreased when the season is over.

One or more database configuration parameters are updated at 814 based on the one or more heuristic rules. In some embodiments, the database configuration parameters may include any configurable elements of the database system, such as a number of available database connections, an amount of computing resources available for executing database queries or performing other database operations, database system usage restrictions, and the like.

A determination is made at 816 as to whether to determine additional contextual statistics. In some embodiments, the determination may be made based at least in part on user input. Alternatively, or additionally, the determination may be made based on whether updates were made in a previous iteration of operations 804 through 814. For instance, additional statistics may continue to be collected and/or the data parameterization may continue to be updated until the compute heuristics and/or database system configuration parameters have stabilized.

In particular embodiments, the determination of contextual statistics may be guided by natural language processing information. For example, text stored in database system records may be analyzed to identify contextual information such as the presence of a holiday period. As another example, a user such as a systems administrator may provide input via natural language, such as an instruction to update the contextual information to reflect a seasonal event.

According to various embodiments, the operations shown in FIG. 8 may be performed in an order different from that shown. Alternatively, or additionally, one or more operations may be omitted.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of multitenant database systems. However, the techniques disclosed herein apply to a wide variety of database systems. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
receiving via a communication interface a request to execute a database query against a database system, the database query capable of being executed in a plurality of database contexts;
determining a database context of the plurality of database contexts in which to execute the database query;
determining a plurality of usage statistic values for the database system, the plurality of usage statistic values including a contextual usage statistic value that is specific to the database context;
determining a database query execution plan via a processor based at least in part on the contextual usage statistic value, the database query execution plan including a plurality of operations to perform to execute the database query within the database context;
determining a database query result by performing the plurality of operations within the database context; and
transmitting an indication of the database query result via the communication interface.

2. The method recited in claim 1, wherein the database query execution plan is retrieved from a database query execution plan cache storing a plurality of database query execution plans.

3. The method recited in claim 2, wherein the plurality of database query execution plans includes two or more database query execution plans corresponding with the database query, the method further comprising:
selecting the database query execution plan from the two or more database query execution plans at least in part by applying a compute heuristic to the contextual usage statistic value.

4. The method recited in claim 1, wherein determining the database query execution plan comprises:
providing the database query and the contextual usage statistic value to a database query planner,
receiving the database query execution plan from the database query planner, and
storing the database query execution plan in a database query execution plan cache.

5. The method recited in claim 4, wherein the database query planner determines a plurality of candidate database query execution plans including the database query execution plan, and wherein the database query planner selects the database query execution plan from the candidate database query execution plans based on a cost model determined at least in part based on the contextual usage statistic value.

6. The method recited in claim 1, the method further comprising:
determining an observed performance statistic value by evaluating performance of the plurality of operations within the database system; and
comparing the observed performance statistic value with historical performance information.

7. The method recited in claim 6, the method further comprising:
updating the historical performance information based on the observed performance statistic value, wherein the historical performance information identifies a change over time in the performance of the plurality of operations within the database system.

8. The method recited in claim 6, the method further comprising:
determining whether the observed performance statistic value satisfies a performance statistic threshold based on comparing the observed performance statistic value with the historical performance information; and
invalidating the database query execution plan upon determining that the observed performance statistic value does not satisfy the performance statistic threshold.

9. The method recited in claim 8, wherein invalidating the database query execution plan comprises removing the database query execution plan from a database query execution plan cache storing a plurality of database query execution plans.

10. The method recited in claim 1, wherein determining the plurality of usage statistic values comprises:
determining a plurality of observed usage statistic values based on database operations information observed by the database system; and
determining a plurality of predicted usage statistic values by applying a prediction model to the plurality of observed usage statistic values.

11. The method recited in claim 1, the method further comprising:
determining a plurality of common usage statistic values for the database system, the plurality of common usage statistic values being general to the database system as a whole, wherein the database query execution plan is also determined based at least in part on the plurality of common usage statistic values.

12. The method recited in claim 1, wherein the database context is specific to a database tenant of a plurality of database tenants.

13. The method recited in claim 12, wherein the contextual usage statistic value is selected from the group consisting of: a volume of database traffic associated with the database tenant, a number of records associated with the database query for the database tenant, and a rate of database requests for the database tenant.

14. The method recited in claim 1, wherein the contextual usage statistic value is a measure of database usage for a unit of computing resources within the database system, the unit of computing resources being selected from the group consisting of: a geographic region, a domain, a subdomain, and one or more servers.

15. A database system comprising:
a communication interface configured to receive a request to execute a database query against a database system, the database query capable of being executed in a plurality of database contexts;
a planning engine configured to determine a database context of the plurality of database contexts in which to execute the database query and to determine a plurality of usage statistic values for the database system, the plurality of usage statistic values including a contextual usage statistic value that is specific to the database context;
a processor configured to determine a database query execution plan via a processor based at least in part on the contextual usage statistic value, the database query execution plan including a plurality of operations to perform to execute the database query within the database context;
a database query execution engine configured to determine a database query result by performing the plurality of operations within the database context, and to transmit an indication of the database query result via the communication interface.

16. The database system recited in claim 15, wherein determining the database query execution plan comprises:
providing the database query and the contextual usage statistic value to a database query planner,
receiving the database query execution plan from the database query planner, and
storing the database query execution plan in a database query execution plan cache.

17. The database system recited in claim 16, wherein the database query planner determines a plurality of candidate database query execution plans including the database query execution plan, and wherein the database query planner selects the database query execution plan from the candidate database query execution plans based on a cost model determined at least in part based on the contextual usage statistic value.

18. One or more non-transitory computer readable media having instructions stored thereon for performing a method, the method comprising:
receiving via a communication interface a request to execute a database query against a database system, the database query capable of being executed in a plurality of database contexts;
determining a database context of the plurality of database contexts in which to execute the database query;
determining a plurality of usage statistic values for the database system, the plurality of usage statistic values including a contextual usage statistic value that is specific to the database context;
determining a database query execution plan via a processor based at least in part on the contextual usage statistic value, the database query execution plan including a plurality of operations to perform to execute the database query within the database context;
determining a database query result by performing the plurality of operations within the database context; and
transmitting an indication of the database query result via the communication interface.

19. The one or more non-transitory computer readable media recited in claim 18, wherein the database query execution plan is retrieved from a database query execution plan cache storing a plurality of database query execution plans, wherein the plurality of database query execution plans includes two or more database query execution plans corresponding with the database query, the method further comprising:
selecting the database query execution plan from the two or more database query execution plans at least in part by applying a compute heuristic to the contextual usage statistic value.

20. The one or more non-transitory computer readable media recited in claim 18, the method further comprising:
determining an observed performance statistic value by evaluating performance of the plurality of operations within the database system;
comparing the observed performance statistic value with historical performance information;
determining whether the observed performance statistic value satisfies a performance statistic threshold based on comparing the observed performance statistic value with the historical performance information; and
invalidating the database query execution plan upon determining that the observed performance statistic value does not satisfy the performance statistic threshold, wherein invalidating the database query execution plan comprises removing the database query execution plan from a database query execution plan cache storing a plurality of database query execution plans.
